(19) United States
(12) Patent Application Publication
(10) Pub. No.: US 2023/0301290 A1
(43) Pub. Date: Sep. 28, 2023

(54) FISHING ROD STORAGE AND TRANSPORTATION

(71) Applicant: Tanner Cade Rector, Early, TX (US)

(72) Inventor: Tanner Cade Rector, Early, TX (US)

(21) Appl. No.: 18/126,368

(22) Filed: Mar. 24, 2023

Related U.S. Application Data
(60) Provisional application No. 63/324,001, filed on Mar. 25, 2022.

(51) Int. Cl. A01K 97/08; B60R 9/06

(52) U.S. Cl. CPC A01K 97/08; B60R 9/065

(57) ABSTRACT

This disclosure describes systems, methods, and devices related to Reel-Safe. A device may include a lockable and removable box configured to be attached to a vehicle bed. The device may include a base plate, wherein said base plate is attachable to the vehicle bed, and a pin or lock for securing the box to the base plate. The device may include a hinged lid, comprising a slot for a plate with a hole that protrudes from inside of the box, and a covering over the plate for securing a lock and protecting it from weather elements. The device may include a snap on a front portion of the box for preventing the rods from sliding around when the lid is open. The device may include drainage holes located at a bottom of the box. The device may include a handle for carrying the box.

### CROSS-REFERENCE TO RELATED PATENT APPLICATION(S)

This application claims the benefit of U.S. Provisional Application No. 63/324,001, filed Mar. 25, 2022, the disclosure of which is incorporated by reference as set forth in full.

### TECHNICAL FIELD

This disclosure relates to storage, and more particularly, to fishing rod storage and transportation.

### BACKGROUND

Most people will transport their fishing rods in the beds of their trucks, and there are multiple reasons why this is not an optimal way to transport these fishing rods. Some of these problems include vulnerability to theft and damage.

### BRIEF DESCRIPTION OF THE DRAWINGS

FIGS. 1-14 and 15A-15C depict illustrative schematic diagrams for a Reel-Safe system, in accordance with one or more example embodiments of the present disclosure.

FIG. 16 illustrates a flow diagram of a process for an illustrative Reel-Safe system, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in or substituted for, those of other embodiments. Embodiments set forth in the claims encompass all available equivalents of those claims.

Example embodiments of the present disclosure relate to systems, methods, and devices for fishing rod storage and transportation.

In one or more embodiments, a Reel-Safe system may solve many problems that fishermen have when transporting their fishing rods. Most people transport their fishing rods in the beds of their trucks, and there are multiple reasons why this may present difficulty in transportation. Some of these problems include vulnerability to the theft of the fishing rods, damage from rolling around the bed, and possibly getting broken from a tailgate. One problem many encounter while traveling is needing to stop and then attempting to move the rods into the cab of the truck, which is not easy and can damage them if not handled carefully. Also, for kayak fishermen, kayaks may be carried in the truck bed and the tailgate has to be down. This creates a problem because the rods may now fall out if stored in the bed of the truck. With the Reel-Safe, it will fit in the corner of the bed, so that the kayak can still fit into the center of the bed, and also allow room for any other cargo. There are no available solutions to attach fishing rods and/or reels for transportation in a truck that will secure the rods and/or reels without having to take the reels off the rod, or need a 2-piece pole. (2 piece poles are rarely used anymore).

In one or more embodiments, a Reel-Safe system may include a lockable and removable box that can be attached to the bed of a truck, that will store the rods and/or reels in a secure way. The Reel-Safe system may comprise a base plate bolted to the bed of the truck; this plate will come through the bottom of the box and be attached with a pin or lock.

To prevent the box from moving or rattling, magnets/foam padding may be added to the base plate. The box may include a top lid (hinged from the side) with a slot for a plate with a hole that protrudes from the inside of the safe. The plate comes through the lid where you can lock the lid down. The Reel-Safe system may include a covering over the plate that the lock will fit into and prevent it from being able to be cut and protect it from weather elements.

In one or more embodiments, when the lid is open, the rods can be inserted and slid into a snap on the front portion of the box that will prevent the rods from sliding around. The bottom of the box will have drainage holes for water to drain out of and the edges of the lid will be hanging over and be less easy to pry open.

In one or more embodiments, a Reel-Safe system may comprise a handle for carrying the safe.

In one or more embodiments, a Reel-Safe system may have the same mechanisms as the previous design (lock & pin with the base plate, lock & cover on the lid, slots for the rods to snap in). However, the shape of the front of the reel-safe is modified. The front will be curved inward so that the safe can be stored in the corner of a truck bed and fit over the inner fender on the truck bed. This design saves more space inside the bed of the truck.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

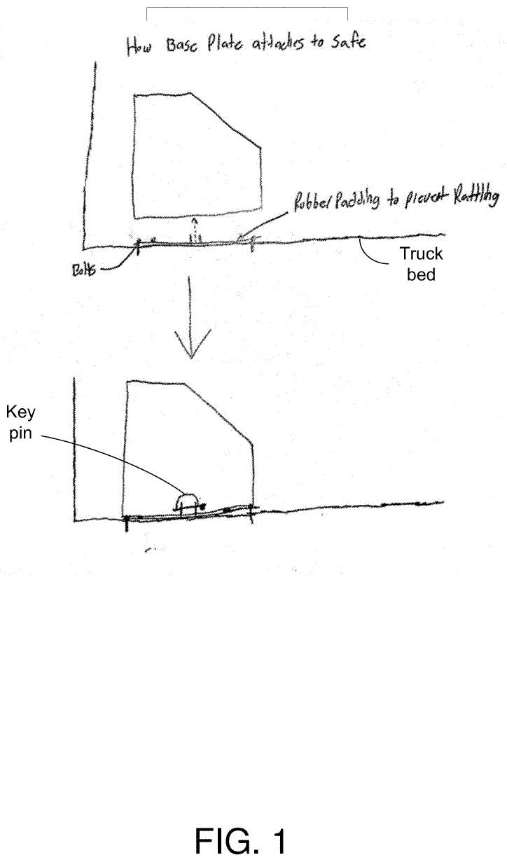

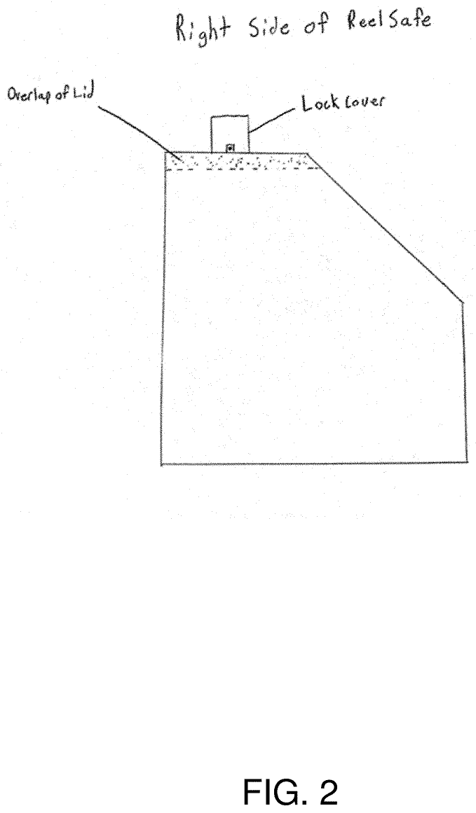

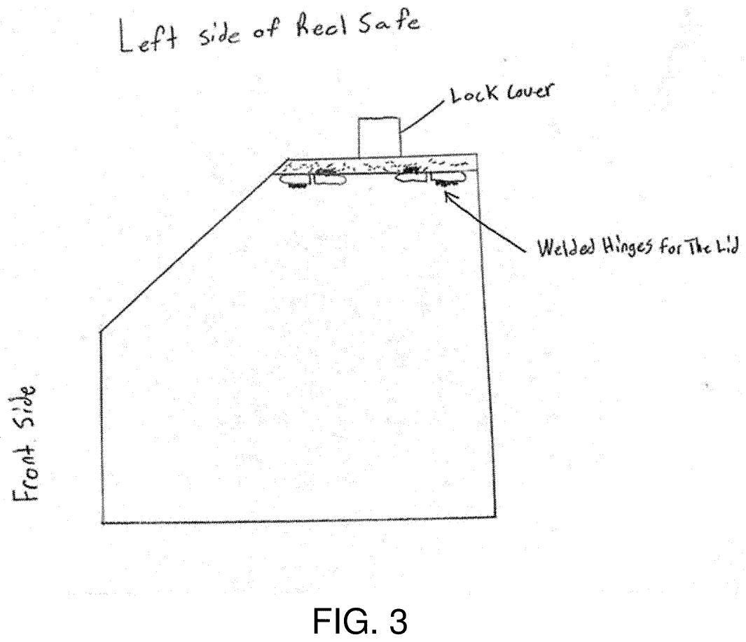

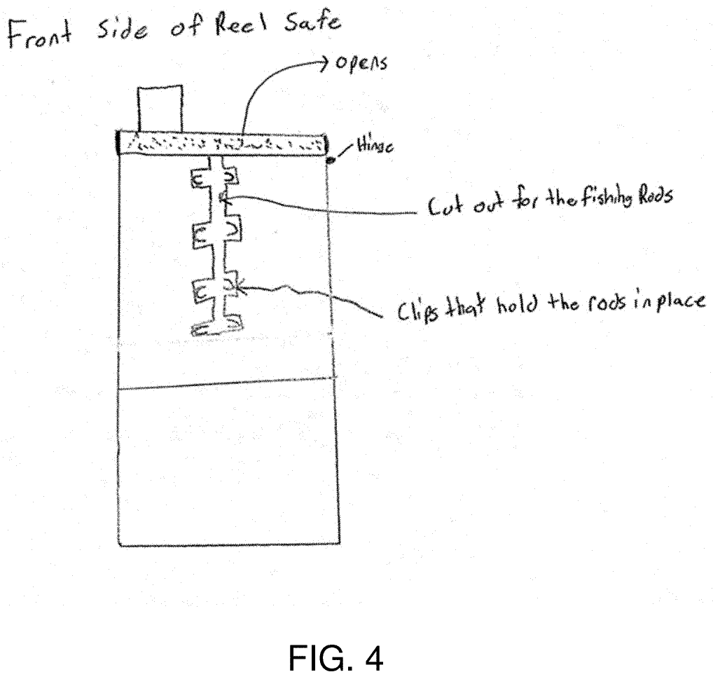

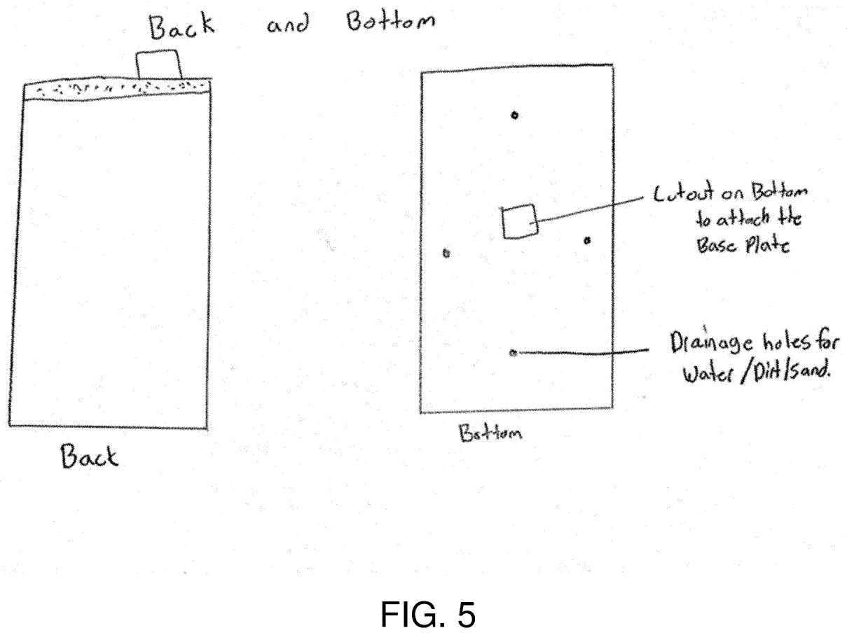

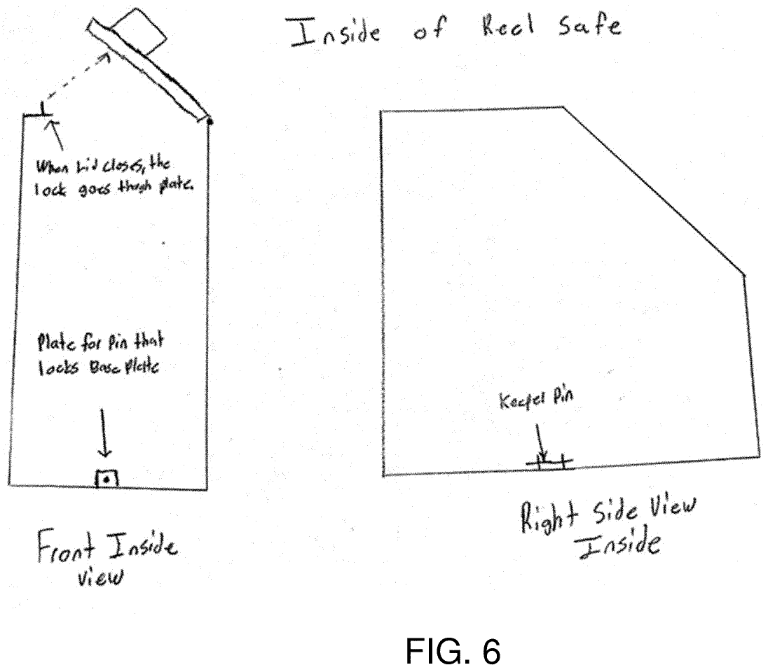

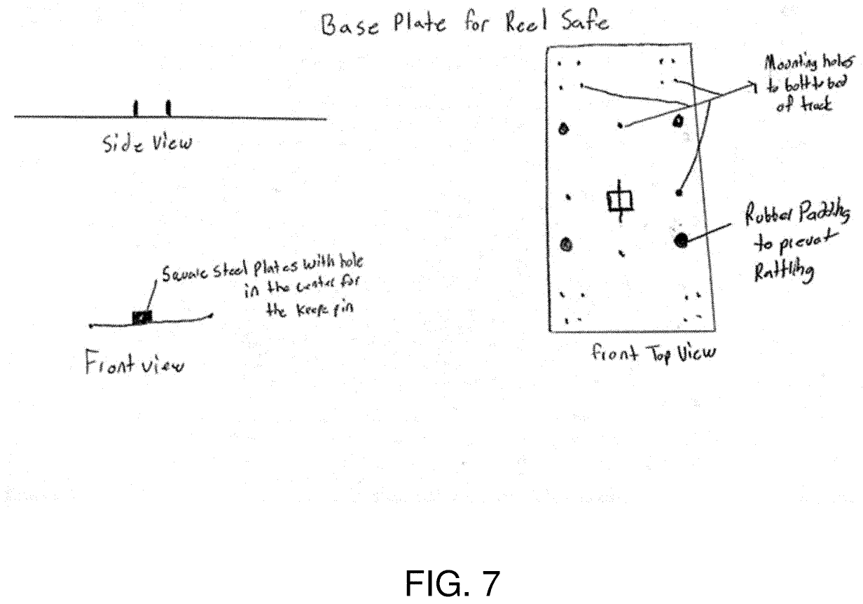

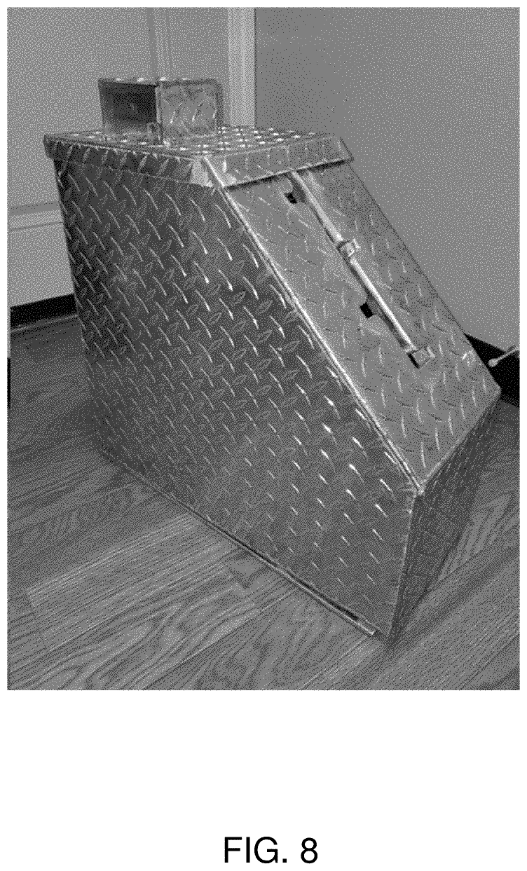

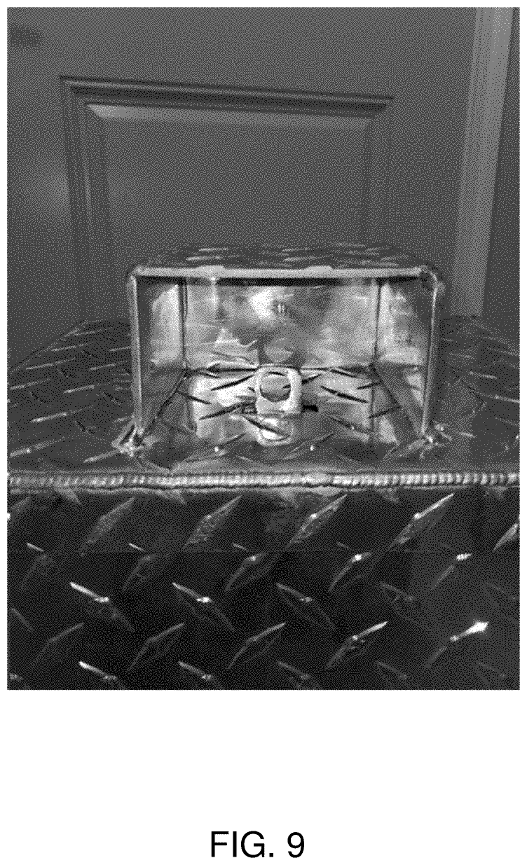

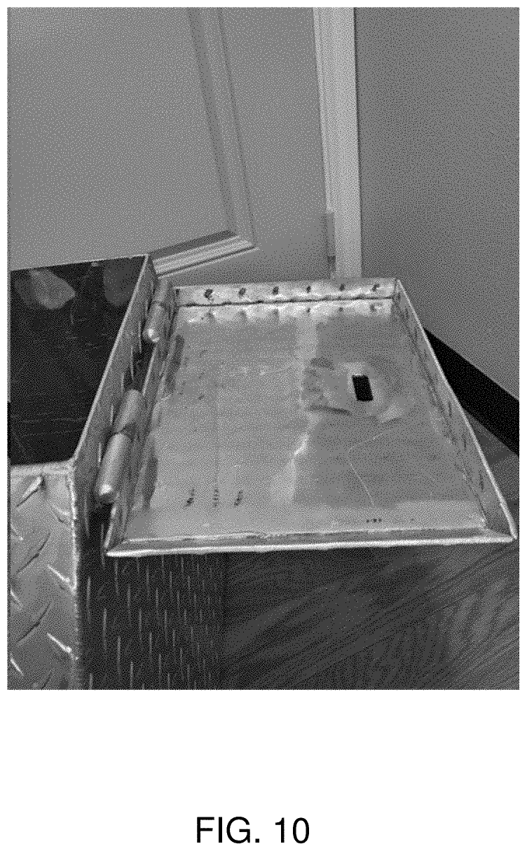

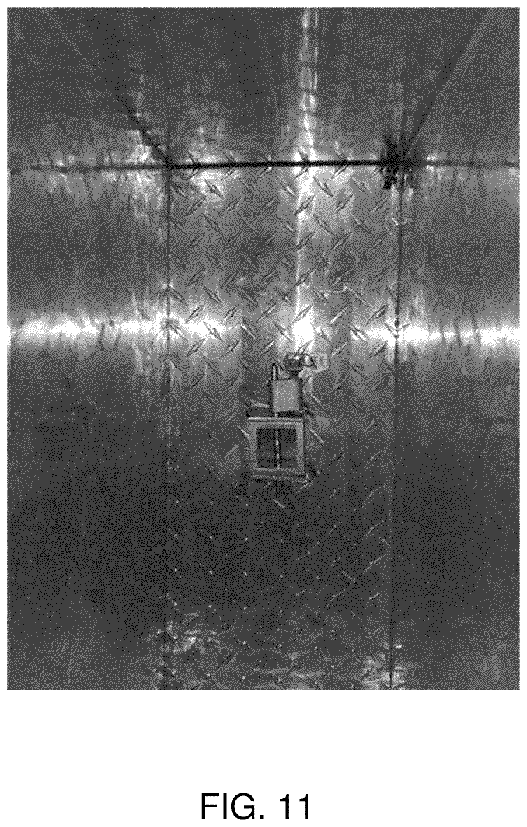

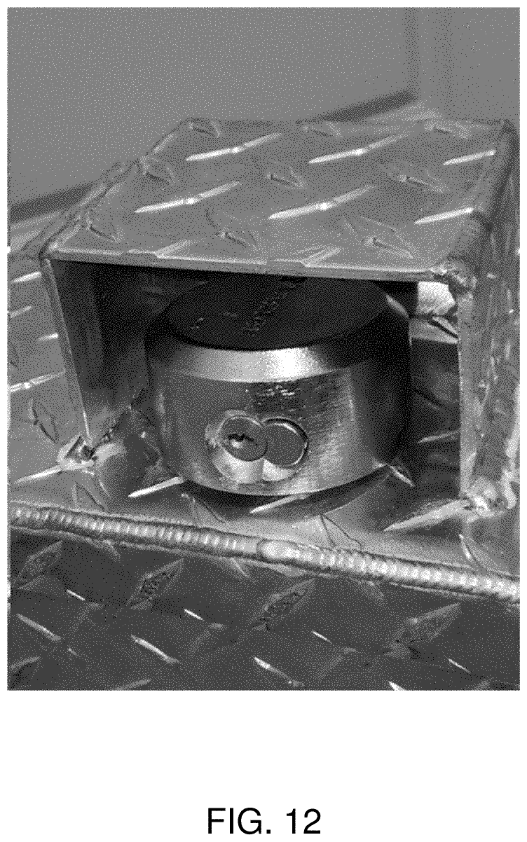

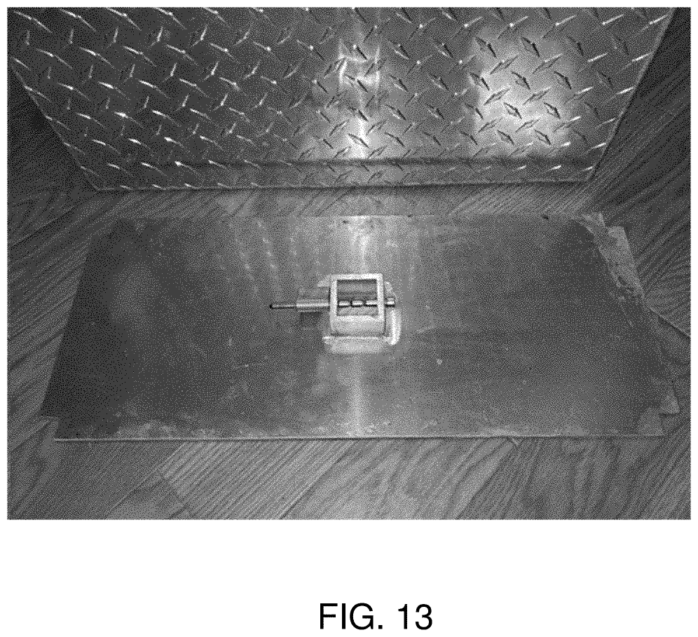

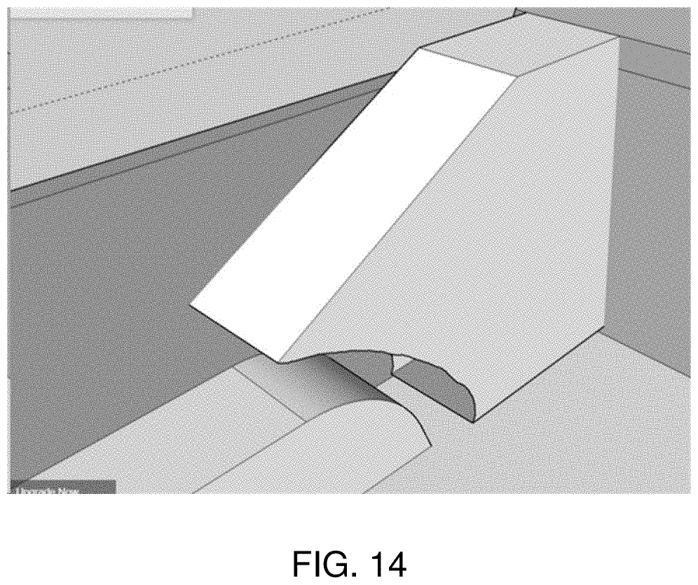

FIGS. 1-14 and 15A-15C depict illustrative schematic diagrams for a Reel-Safe system, in accordance with one or more example embodiments of the present disclosure.

In one or more embodiments, a Reel-Safe system may comprise at least two implementations. The first implementation is a welded/bent metal aluminum version that will have the base plate that is bolted to the bed. This will be a secure version available as well as more expensive. The metal can be bent with a machine so that there only needs to be one seam welded which would cut the cost of welding. These can be made with precut sheets. This model is for the more serious fisherman that would need this on a daily or weekly basis that many coastal people actually need.

The first implementation may be an easier to remove and carry a plastic version that will have magnets on the bottom and be able to be locked to the bed of the truck via a cable or chain. This would also be a cheaper model and could be more sellable to people who want some security for certain trips.

In one or more embodiments, a Reel-Safe system may include accessories that can attach to the sides of the safe. In one or more embodiments, a Reel-Safe system may include an extendable metal rod that can be attached to two safes across the width of the bed that will have rod holders spread across for surf fishing. In another embodiment, a Reel-Safe system may include adding a 90-degree angle that can be attached to the bed just as the base plate is connected to the bed.

In one or more embodiments, another accessory may be a tube that attaches to the side of the Reel-safe, designed to hold the top part of 2-piece rods that are too long to leave together while traveling. This maybe used for coastal fishermen with big surf rods.

In addition to the truck bed applications mentioned above, example embodiments of the Reel-Safe system may be adapted for use in various other vehicles, such as SUVs, vans, or cars with roof racks. This would provide a broader range of applications for the Reel-Safe system, making it more versatile and accessible to a wider range of customers.

The Reel-Safe system may also be adapted for use in watercraft, such as boats or personal watercraft, providing secure storage and transportation of fishing rods and/or reels while on the water. This could help protect fishing equipment from damage caused by rough water conditions, as well as prevent theft or loss of equipment when unattended.

In one or more embodiments, the Reel-Safe system may include adjustable compartments within the box, allowing for customization of the storage space to accommodate different types and sizes of fishing rods and/or reels. This would enable users to tailor the system to their specific needs, making it more user-friendly and practical.

The Reel-Safe system may also incorporate additional features to improve usability and functionality. For example, integrated lighting systems could be added to the box to facilitate visibility in low light conditions or during nighttime use. Another feature could include built-in rod holders or clips on the exterior of the box, allowing for quick and easy access to frequently used rods and/or reels.

In one or more embodiments, the Reel-Safe system may be designed with environmentally friendly materials and manufacturing processes. This could involve using recycled or sustainable materials in the construction of the box, as well as implementing eco-friendly manufacturing processes to reduce the overall environmental impact of the product.

The Reel-Safe system could be offered in various sizes and configurations to accommodate different customer needs and preferences. This may include compact versions for those with limited storage space or transport capacity, as well as larger, more comprehensive systems for professional fishermen or those with extensive collections of rods and/or reels.

The Reel-Safe system may also be developed as a modular system, with different components and accessories that can be easily added or removed as needed. This would allow customers to customize their storage solution according to their specific requirements, while also providing the flexibility to adapt and expand the system as their needs change over time.

In summary, the Reel-Safe system offers a versatile and secure solution for the storage and transportation of fishing rods and/or reels. By expanding on the initial design and exploring additional applications, accessories, and features, the Reel-Safe system can be tailored to meet the needs of various users and environments, ultimately enhancing its appeal and market potential.

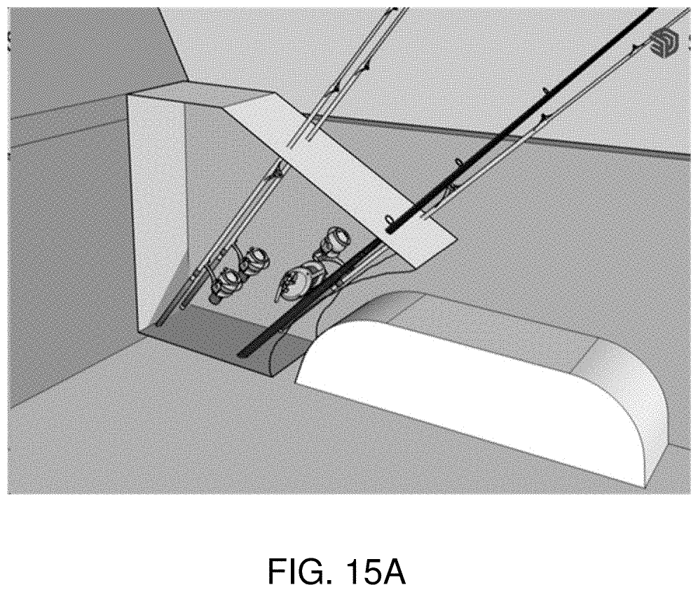

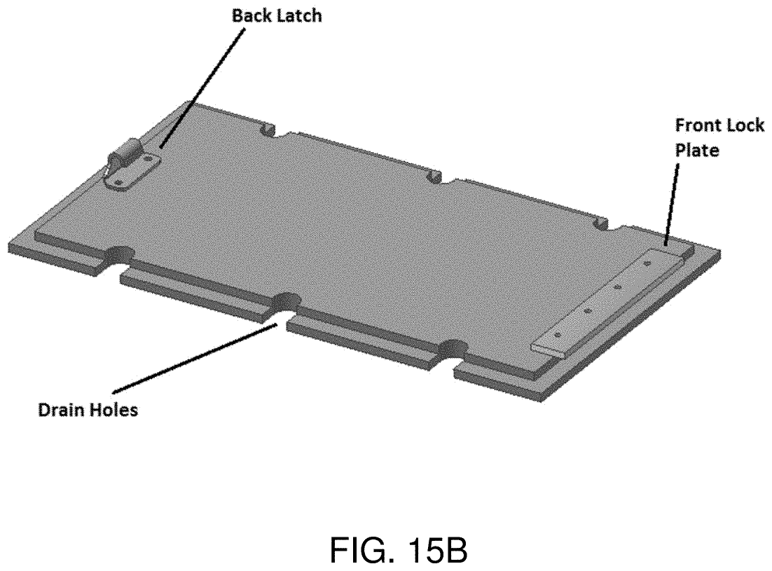

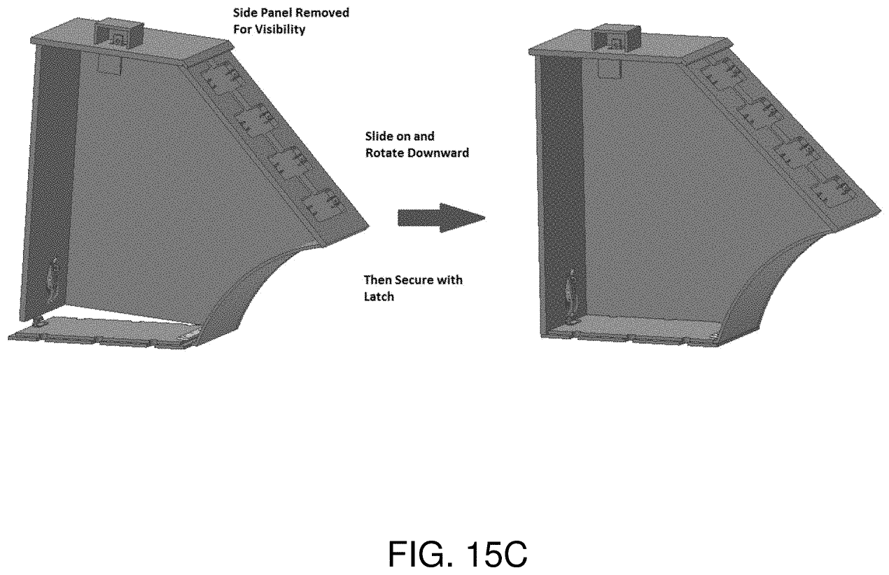

Referring to FIG. 15B and FIG. 15C, they illustrate a design of the bottom plate and how it is securely nested with the top plate. The bottom plate is strategically skived along the edges to allow the top plate to fit snugly over the center portion, while a spring latch at the back and a hinge plate on the front prevent any rattling or displacement. This innovative latch mechanism eliminates the need for multiple latches, while the interior latch can be secured with a padlock for added security. Overall, this design represents a significant improvement over traditional latch mechanisms, offering enhanced functionality, convenience, and security.

It is understood that the above descriptions are for purposes of illustration and are not meant to be limiting.

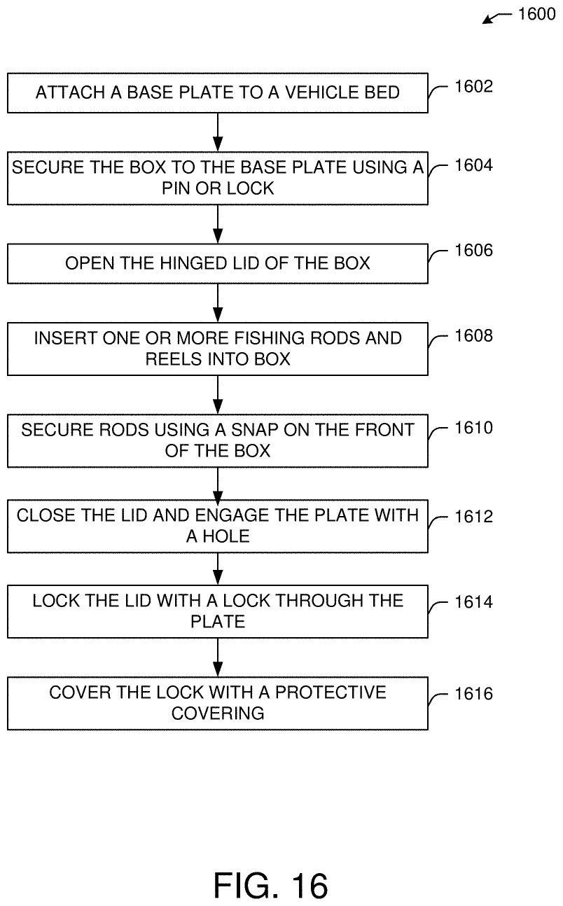

FIG. 16 illustrates a flow diagram of a process 1600 for an illustrative Reel-Safe system, in accordance with one or more example embodiments of the present disclosure.

At block 1602, a device may attach a base plate to a vehicle bed.

At block 1604, the device may secure the box to the base plate using a pin or lock.

At block 1606, the device may open the hinged lid of the box.

At block 1608, the device may insert one or more fishing rods into box.

At block 1610, the device may secure rods using a snap on the front of the box.

At block 1612, the device may close the lid and engage the plate with a hole.

At block 1614, the device may lock the lid with a lock through the plate.

At block 1616, the device may cover the lock with a protective covering.

In one or more embodiments, the the box may be configured to be stored in a corner of a truck bed and fit over an inner fender on the truck bed.

The device further comprises an adjustable compartment within the box, allowing for customization of storage space to accommodate different types and sizes of fishing rods.

The device further comprises built-in rod holders or clips on an exterior of the box, allowing for quick and easy access to frequently used rods.

The device further comprises a weather-resistant seal on the lid, preventing moisture and debris from entering the box and protecting the fishing rods stored inside.

The device further comprises one or more ventilation openings allowing for air circulation within the box, promoting drying and reducing a likelihood of mildew and corrosion on the stored fishing rods.

The device further comprises one or more accessories attachable to the box.

The device further comprises at least one of an extendable metal rod, a 90-degree angle attachment, or a tube for holding a top part of 2-piece rods as an accessory.

It is understood that the above descriptions are for purposes of illustration and are not meant to be limiting.

The word “exemplary” is used herein to mean “serving as an example, instance, or illustration.” Any embodiment described herein as “exemplary” is not necessarily to be construed as preferred or advantageous over other embodiments.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A Reel-Safe system for fishing rod storage and transportation, comprising:
a lockable and removable box configured to be attached to a vehicle bed;
a base plate, wherein said base plate is attachable to the vehicle bed, and a pin or lock for securing the box to the base plate;
a hinged lid, comprising a slot for a plate with a hole that protrudes from inside of the box, and a covering over the plate for securing a lock and protecting it from weather elements;
a snap on a front portion of the box for preventing the rods from sliding around when the lid is open;
drainage holes located at a bottom of the box; and
a handle for carrying the box.

2. The Reel-Safe system of claim 1, wherein the box is configured to be stored in a corner of a truck bed and fit over an inner fender on the truck bed.

3. The Reel-Safe system of claim 1, further comprising an adjustable compartment within the box, allowing for customization of storage space to accommodate different types and sizes of fishing rods.

4. The Reel-Safe system of claim 1, further comprising built-in rod holders or clips on an exterior of the box, allowing for quick and easy access to frequently used rods.

5. The Reel-Safe system of claim 1, wherein the box further comprises a weather-resistant seal on the lid, preventing moisture and debris from entering the box and protecting the fishing rods stored inside.

6. The Reel-Safe system of claim 1, wherein the box further comprises one or more ventilation openings allowing for air circulation within the box, promoting drying and reducing a likelihood of mildew and corrosion on the stored fishing rods.

7. The Reel-Safe system of claim 1, further comprising one more accessories attachable to the box.

8. The Reel-Safe system of claim 7, wherein the one or more accessories comprise at least one of an extendable metal rod, a 90-degree angle attachment, or a tube for holding a top part of 2-piece rods.

9. A method of storing and transporting fishing rods using a Reel-Safe system, the method comprising:
attaching a base plate to a vehicle bed;
securing a lockable and removable box to the base plate using a pin or lock;
opening a hinged lid of the box; inserting one or more fishing rods into the box;
securing the one or more fishing rods in place using a snap on a front portion of the box;
closing the hinged lid, engaging a plate with a hole that protrudes from inside of the box; and
locking the lid with a lock through the plate, and covering the lock with a protective covering.

10. The method of claim 9, further comprising storing the box in a corner of a truck bed and fitting the box over an inner fender on the truck bed.

11. The method of claim 9, further comprising adjusting compartments within the box to accommodate different types and sizes of fishing rods.

12. The method of claim 9, further comprising utilizing built-in rod holders or clips on an exterior of the box for quick and easy access to frequently used rods.

13. The method of claim 9, further comprising sealing the lid with a weather-resistant seal to prevent moisture and debris from entering the box and protecting the stored fishing rods.

14. The method of claim 9, further comprising providing air circulation within the box through one or more ventilation openings, promoting drying and reducing a likelihood of mildew and corrosion on the stored fishing rods.

15. The method of claim 9, further comprising attaching one or more accessories to the box.

16. The method of claim 15, wherein attaching one or more accessories to the box comprises attaching at least one of an extendable metal rod, a 90-degree angle attachment, or a tube for holding a top part of 2-piece rods.

17. An apparatus for fishing rod storage and transportation, the apparatus comprising:
a lockable and removable box configured to be attached to a vehicle bed;
a base plate configured to be attached to the vehicle bed, the base plate further comprising a pin or lock for securing the box to the base plate;
a hinged lid having a slot for a plate with a hole that protrudes from inside of the box, and a covering over the plate for securing a lock and protecting it from weather elements;
a snap on a front portion of the box for preventing the rods from sliding around when the lid is open;
drainage holes located at a bottom of the box;
and a handle for carrying the box.

18. The apparatus of claim 17, wherein the box is configured to be stored in a corner of a truck bed and fit over an inner fender on the truck bed.

19. The apparatus of claim 17, further comprising an adjustable compartment within the box, allowing for customization of a storage space to accommodate different types and sizes of fishing rods.

20. The apparatus of claim 17, further comprising built-in rod holders or clips on an exterior of the box, allowing for quick and easy access to frequently used rods.
